(19) United States
(12) Patent Application Publication
(10) Pub. No.: US 2018/0193830 A1
(43) Pub. Date: Jul. 12, 2018

(54) BIOPSY SAMPLE CONTAINER

(71) Applicant: OLYMPUS CORPORATION, Tokyo (JP)

(72) Inventors: Kazutaka NISHIKAWA, Tokyo (JP); Seiji KONDO, Tokyo (JP)

(73) Assignee: OLYMPUS CORPORATION, Tokyo (JP)

(21) Appl. No.: 15/913,287

(22) Filed: Mar. 6, 2018

Related U.S. Application Data
(63) Continuation of application No. PCT/JP2015/076844, filed on Sep. 24, 2015.

(51) Int. Cl. B01L 3/00

(52) U.S. Cl. CPC B01L 3/508; B01L 3/523; B01L 2300/0672; B01L 2300/047; B01L 2200/16

(57) ABSTRACT

A biopsy sample container according to the present disclosure includes: a sample containing section capable of containing a biological sample, a reagent containing section capable of containing a reagent, a sealing layer that separates the reagent containing section and the sample containing section from each other in a liquid-tight state, a seal-breaking section that is movable relative to the sealing layer and that moves relative thereto so as to form a through-hole in the sealing layer, and a resealing section that closes the through-hole formed by the seal-breaking section.

### CROSS-REFERENCE TO RELATED APPLICATIONS

This is a Continuation Application of International Application No. PCT/JP2015/076844 filed on Sep. 24, 2015, the content of which is hereby incorporated by reference herein in its entirety.

### TECHNICAL FIELD

The present invention relates to biopsy sample containers.

### BACKGROUND ART

A known biopsy sample container contains a biological sample within a first container having an opening at one end thereof and contains a reagent within a second container sealed by means of a pierceable film. When connecting the two containers together, the film is pierced by means of a protrusion provided in the first container so that the reagent within the second container can be fed to the biological sample within the first container (for example, see PCT International Publication No. WO 2008/152980).

### SUMMARY OF INVENTION

An aspect of the present disclosure is a biopsy sample container including: a sample containing section capable of containing a biological sample; a reagent containing section capable of containing a reagent; a sealing layer that separates the reagent containing section and the sample containing section from each other in a liquid-tight state; a seal-breaking section that forms a through-hole in the sealing layer by movement relative to the sealing layer; and a resealing section that closes the through-hole formed by the seal-breaking section.

### BRIEF DESCRIPTION OF DRAWINGS

FIG. 1 is a cross-sectional view illustrating a state where a reagent containing section and a sample containing section are separated from each other in a biopsy sample container according to an embodiment of the present invention.

FIG. 2 is a longitudinal sectional view illustrating the biopsy sample container in FIG. 1.

FIG. 3 is a cross-sectional view illustrating a state where a through-hole is formed in a film member by means of a protrusion of the biopsy sample container in FIG. 1.

FIG. 4 is a vertical sectional view illustrating the biopsy sample container in FIG. 3.

FIG. 5 is a cross-sectional view illustrating a state where a reagent is flowing through the through-hole formed in the film member of the biopsy sample container in FIG. 1.

FIG. 6A is a partially enlarged view illustrating a modification of the protrusion of the biopsy sample container in FIG. 1.

FIG. 6B is a partially enlarged view illustrating a state where a through-hole is formed in the film member by means of the protrusion in FIG. 6A.

FIG. 6C is a partially enlarged view illustrating a state where the through-hole formed in FIG. 6B is closed by a plate-shaped section.

FIG. 7 is a vertical sectional view illustrating an example where a seal member is disposed in the plate-shaped section of the biopsy sample container in FIG. 6A.

FIG. 8 is a partially enlarged view illustrating a modification of the protrusion of the biopsy sample container in FIG. 6A.

FIG. 9A is a vertical sectional view illustrating a modification of the biopsy sample container in FIG. 1.

FIG. 9B is a vertical sectional view illustrating a state where a through-hole is formed in the film member by means of the protrusion of the biopsy sample container in FIG. 9A.

FIG. 9C is a vertical sectional view illustrating a state where the through-hole formed in FIG. 9B is closed by a flat surface section.

FIG. 10A is a vertical sectional view illustrating another modification of the biopsy sample container in FIG. 1.

FIG. 10B is a vertical sectional view illustrating a state where a through-hole is formed in the film member by means of the protrusion of the biopsy sample container in FIG. 10A.

FIG. 10C is a vertical sectional view illustrating a state where the through-hole formed in FIG. 10B is closed by the flat surface section.

### DESCRIPTION OF EMBODIMENT

A biopsy sample container 1 according to an embodiment of the present invention will be described below with reference to the drawings.

Before proceeding with the description of the embodiment, a biological sample A may include any material derived from a biological organism and may refer to, for example, solid samples such as excrement, nails, hair, or tissues, or liquid samples such as blood, sputum, saliva, or urine. A reagent B may be an organic solvent or a solution containing an organic solvent. The organic solvent used may be, for example, phenol or chloroform. It is more preferable to employ a reagent B containing a water-soluble organic solvent as an active ingredient.

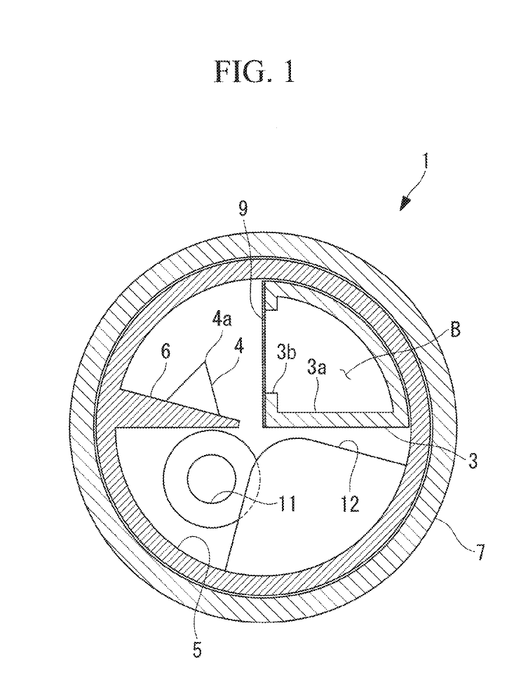

As shown in FIGS. 1 to 4, the biopsy sample container 1 according to this embodiment includes a sample container (second container) 2 having a sample containing section 2a that contains the biological sample A and a reagent container (first container) 3 having a reagent containing section 3a that contains the reagent B.

The sample container 2 is a bottomed cylinder with one end of which has an opening 2b and the other end of which is closed by a base 2c.

A male thread 2d is formed on the outer peripheral surface near the opening 2b of the sample container 2. A ring-shaped member 5 having a protrusion 4 is fixed to the end at the opening 2b side of the sample container 2. The ring-shaped member 5 includes a plate-shaped section (contact member, resealing section) 6 protruding radially inward and extending in the axial direction. One surface of the plate-shaped section 6 is provided with the protrusion (seal-breaking section) 4. The protrusion 4 gradually tapers from the plate-shaped section 6 toward a pointed end 4a.

A seal member 8, such as an O-ring, is disposed on the outer peripheral surface of the ring-shaped member 5 so as to seal the gap between the outer peripheral surface and the inner surface of a cap member 7, which will be described below.

The reagent container 3 is integrally provided with the cap member 7, which is cylindrical, so as to protrude inward in the axial direction from an end surface of the cap member 7 having a female thread 7a to be fastened to the male thread 2d of the sample container 2. A surface of the reagent container 3 extending in the axial direction is provided with an opening 3b. The opening 3b is closed in a liquid-tight state by a thin film member (sealing layer) 9. Accordingly, the reagent B contained within the reagent container 3 is maintained in the contained state within the reagent container 3 unless the film member 9 breaks.

By using the cap member 7 provided with the reagent container 3 to cover so as to close the opening 2b of the sample container 2, the reagent container 3 is inserted into the sample container 2. Thus, the protrusion 4 provided on the plate-shaped section 6 of the ring-shaped member 5 is disposed at a position where it opposes, in the circumferential direction, the film member 9 closing the opening 3b of the reagent container 3.

Furthermore, the gap between the inner surface of the cap member 7 and the outer surface of the ring-shaped member 5 is hermetically sealed by the seal member 8 interposed therebetween, so that the opening 2b of the sample container 2 is hermetically sealed to the outside.

When the female thread 7a of the cap member 7 is fastened to the male thread 2d of the sample container 2 in this state, the cap member 7 is rotated relative to the sample container 2 about the axis of the sample container 2.

Because the ring-shaped member 5 is fixed to the sample container 2, the reagent container 3 provided integrally with the cap member 7 moves in the circumferential direction when the cap member 7 is rotated relative to the sample container 2, thus causing the protrusion 4 to move closer toward the film member 9. Consequently, as the cap member 7 is rotated relative to the sample container 2, the protrusion 4 comes into contact with the film member 9 and forms a through-hole 10 therein.

As the cap member 7 is further rotated relative to the sample container 2 from the state where the through-hole 10 is formed, the plate-shaped section 6 disposed at the root of the protrusion 4 is brought into close contact with the surface of the film member 9.

Moreover, the cap member 7 is provided with a supply hole 11 for supplying the biological sample A into the sample container 2 in the state where the opening 2b is closed by the cap member 7. For example, the supply hole 11 has a diameter that allows an injection needle of a syringe containing the biological sample A to penetrate therethrough.

Furthermore, the ring-shaped member 5 is provided with a closing plate 12 that closes the supply hole 11 at the time when the protrusion 4 penetrates the film member 9. The closing plate 12 has the shape of a flat plate that protrudes radially inward from near an end of the ring-shaped member 5. The cap member 7 is rotated relative to the sample container 2 so as to close the supply hole 11 near a relative position where the protrusion 4 reaches the film member 9, thereby shutting off the sample container 2 in a sealed state from the outside.

The operation of the biopsy sample container 1 according to this embodiment having the above-described configuration will be described below.

In order to mix the biological sample A and the reagent B using the biopsy sample container 1 according to this embodiment, the reagent B is contained within the reagent containing section 3a of the reagent container 3 provided in the cap member 7, and the opening 3b is sealed by using the film member 9. By using the cap member 7 in this state, the opening 2b of the sample container 2 is closed.

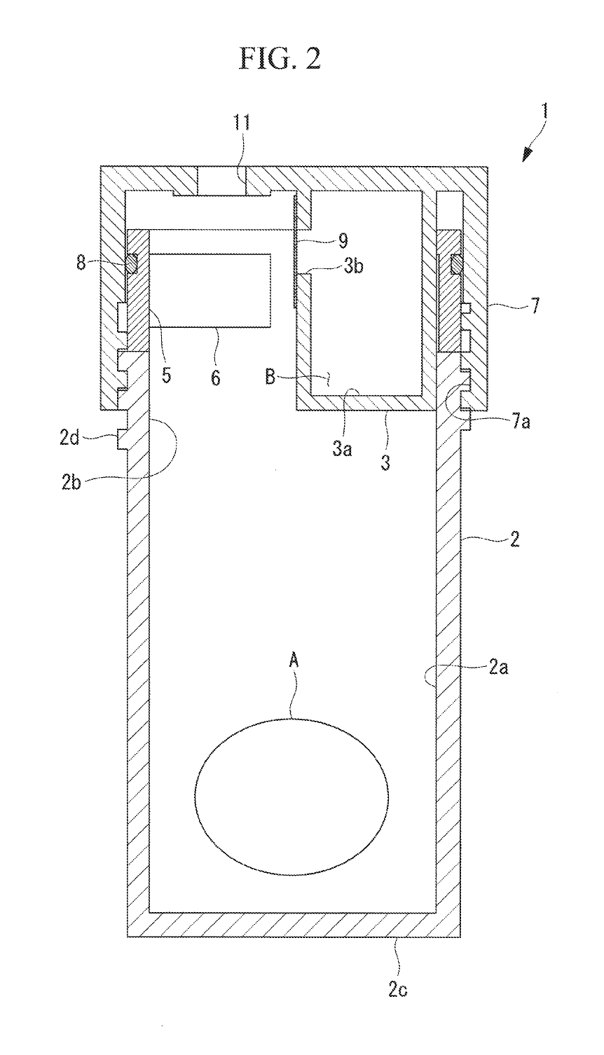

Specifically, as shown in FIG. 2, the cap member 7 is used to keep the sample container 2 in a sealed state by engaging a part of the female thread 7a of the cap member 7 with a part of the male thread 2d of the sample container 2. In this state, as shown in FIG. 1, the protrusion 4 and the film member 9 are disposed at positions separated from each other in the circumferential direction.

The biological sample A is fed into the sample container 2 in the state shown in FIGS. 1 and 2 via the supply hole 11 of the cap member 7. Because the supply hole 11 is open, the biological sample A can be readily contained within the sample containing section 2a of the sample container 2.

In this state, an operator rotates the cap member 7 relative to the sample container 2 about the axis of the sample container 2. This causes the female thread 7a of the cap member 7 to be further fastened to the male thread 2d of the sample container 2 so that the cap member 7 is brought close to be drawn in the axial direction with respect to the sample container 2. Moreover, the reagent container 3 provided in the cap member 7 is moved in the circumferential direction so as to be brought close to the protrusion 4 of the ring-shaped member 5.

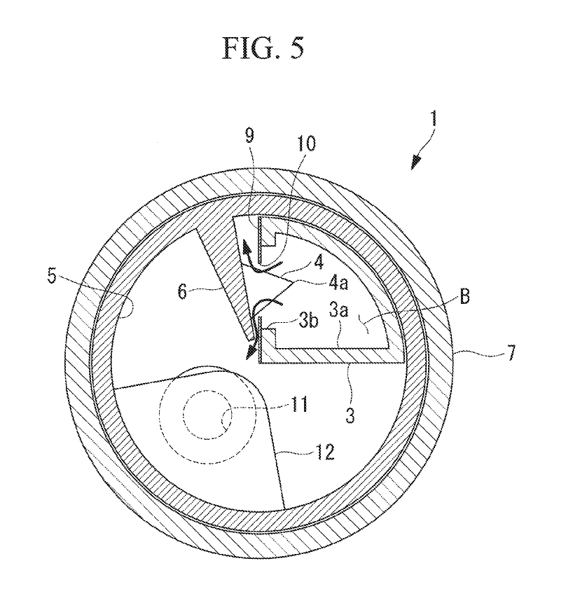

Then, when the cap member 7 is rotated relative to the sample container 2 by a predetermined angle, the protrusion 4 provided in the ring-shaped member 5 forms the through-hole 10 in the film member 9 closing the opening 3b of the reagent container 3, as shown in FIG. 5. As a result, the reagent B sealed within the reagent container 3 flows out into the sample container 2 via the through-hole 10 in the film member 9, as indicated by the arrows, so that the reagent B can be fed to and mixed with the biological sample A contained within the sample container 2.

As shown in FIG. 5, at this point, the closing plate 12 provided in the ring-shaped member 5 closes the supply hole 11 of the cap member 7 so as to shut off the internal space of the biopsy sample container 1 from the external space.

Accordingly, the operator can mix the reagent B and the biological sample A together without touching them or without aspirating volatile substance.

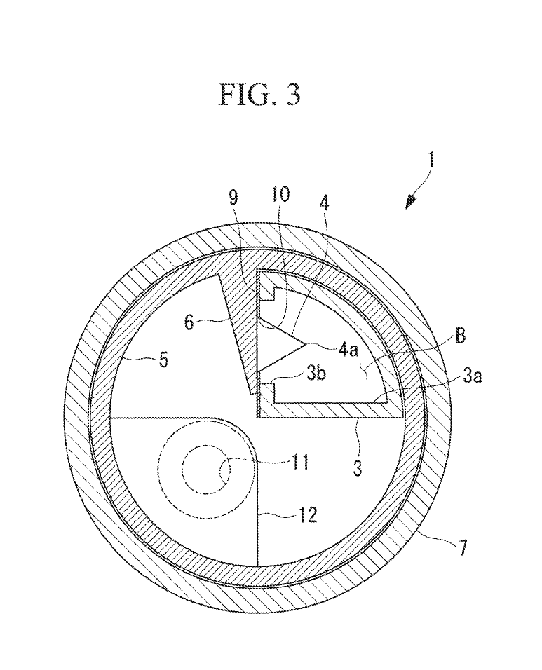

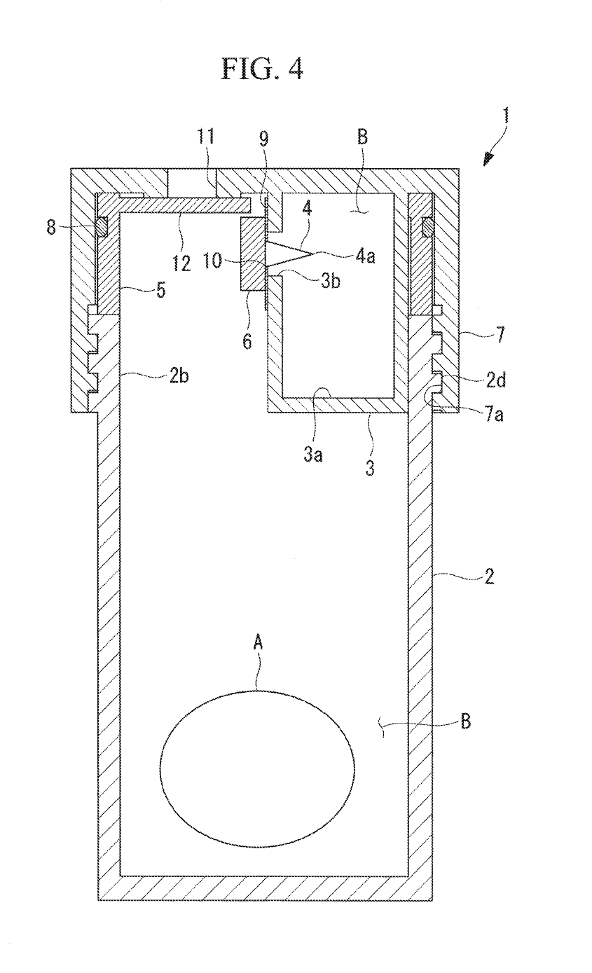

Furthermore, as shown in FIGS. 3 and 4, when the operator rotates the cap member 7 relative to the sample container 2 in the same direction about the axis of the sample container 2, the plate-shaped section 6 comes into close contact with the surface of the film member 9 so that the through-hole 10 formed in the film member 9 is closed again by the plate-shaped section 6. Thus, the mixture of the reagent B and the biological sample A mixed within the sample container 2 can be prevented from backflow into the reagent container 3 via the through-hole 10 formed in the film member 9.

Accordingly, the biopsy sample container 1 according to this embodiment is advantageous in that the operator can mix the biological sample A and the reagent B together in the sealed biopsy sample container 1 by simply injecting the collected biological sample A into the sample container 2 through the supply hole 11 by using a syringe and then rotating the cap member 7 relative to the sample container 2.

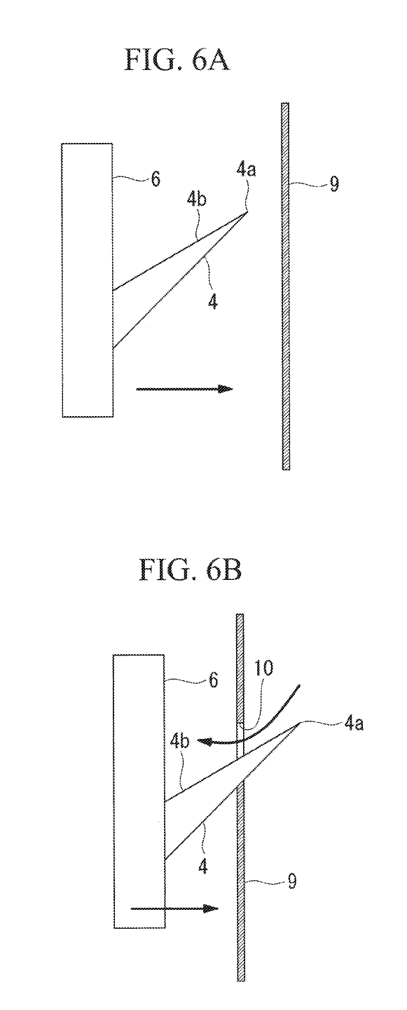

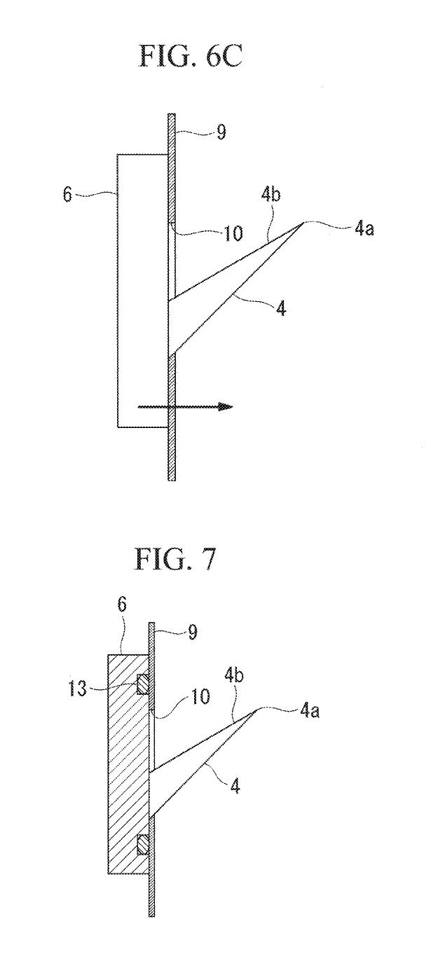

As an alternative to this embodiment in which the protrusion 4 used gradually tapers toward the pointed end 4a, the protrusion 4 may be inclined in one direction toward the pointed end 4a, as shown in FIGS. 6A to 6C. Thus, the protrusion 4 has a recess 4b formed on the proximal end thereof relative to the pointed end 4a.

Accordingly, when the protrusion 4 forms the through-hole 10 in the film member 9, as shown in FIG. 6B, while the plate-shaped section 6 is brought close to the film member 9, as shown in FIG. 6A, the position where the protrusion 4 pierces the film member 9 is gradually shifted along the surface of the film member 9 so that the gap between the through-hole 10 and the protrusion 4 is widened.

As a result, the reagent B within the reagent container 3 can readily flow toward the sample container 2, as indicated by an arrow, so that the reagent B can be mixed with the biological sample A more quickly. Then, when the plate-shaped section 6 is brought further closer to the film member 9, the plate-shaped section 6 is brought into close contact with the surface of the film member 9 around the entire periphery surrounding the through-hole 10, as shown in FIG. 6C, whereby the through-hole 10 becomes closed by the plate-shaped section 6.

Accordingly, the mixture of the reagent B and the biological sample A can be prevented from backflow into the reagent container 3.

Specifically, by using such a protrusion 4, the process for formation of the through-hole 10 in the film member 9 and the process for release of the reagent B as well as prevention of the reagent B from backflow can be sequentially performed by simply moving the plate-shaped section 6 provided with the protrusion 4 in one direction relative to the film member 9.

Furthermore, as shown in FIG. 7, a seal member 13, such as an O-ring, may be disposed at a position surrounding the protrusion 4 on the surface of the plate-shaped section 6. Accordingly, instead of bringing the plate-shaped section 6 into contact with the surface of the film member 9, the seal member 13 is brought into close contact with the entire periphery around the through-hole 10 so that the through-hole 10 can be closed more reliably.

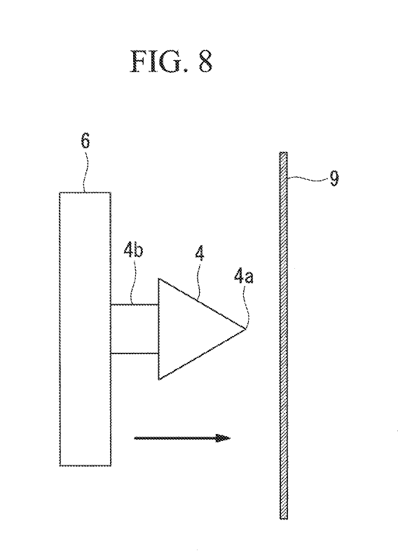

As an alternative to the protrusion 4 that is inclined in one direction, the protrusion 4 may include a recess 4b, which is depressed in a direction intersecting the longitudinal direction, at the proximal end of the protrusion 4 that gradually tapers toward the pointed end 4a, as shown in FIG. 8. Accordingly, after the protrusion 4 forms the through-hole 10 in the film member 9 and the part of the protrusion 4 with the maximum diameter passes through the film member 9, the film member 9 is disposed at the position of the recess 4b, so that the gap between the protrusion 4 and the through-hole 10 is increased, whereby the reagent B can readily flow out therethrough.

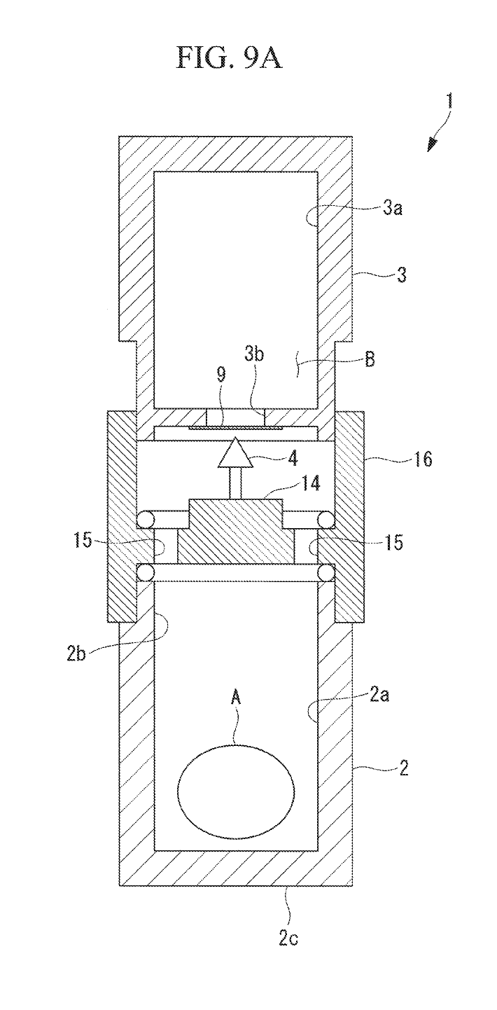

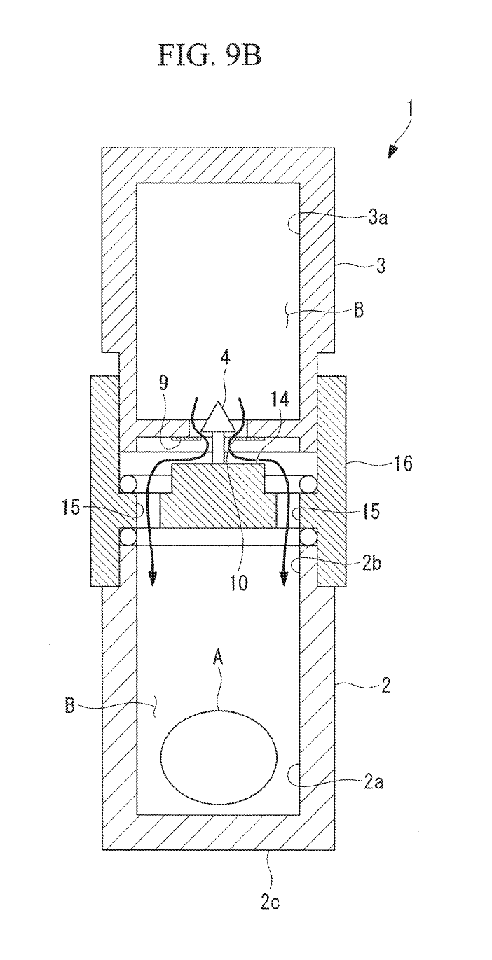

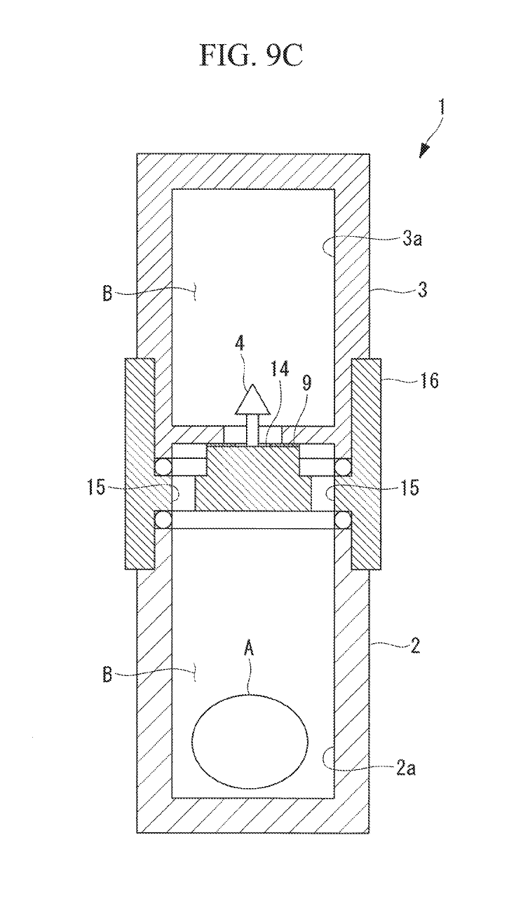

Furthermore, in this embodiment, the reagent container 3 is rotated relative to the sample container 2 about the longitudinal axis of the sample container 2 so that both containers 2 and 3 are moved relative to each other. Alternatively, as shown in FIGS. 9A to 9C, the reagent container 3 may be moved relative to the sample container 2 in the longitudinal direction of the sample container 2.

Specifically, the reagent B is contained in the reagent container 3 and is sealed therein by the film member 9, and a connection member 16 having the protrusion 4, a flat surface section (contact member, resealing section) 14, and an inlet 15 toward the sample container 2 is fixed to the sample container 2. As shown in FIG. 9A, after the biological sample A is contained within the sample container 2, the sample container 2 and the reagent container 3 are connected to each other by means of the connection member 16 in a state where they are shut off from the outside. Then, as shown in FIG. 9B, the sample container 2 and the reagent container 3 are relatively brought close to each other.

Accordingly, the through-hole 10 is formed in the film member 9 by the protrusion 4, so that the reagent B within the reagent container 3 is caused to flow into the sample container 2 via the through-hole 10 and the inlet 15, as indicated by arrows, thereby facilitating the mixing process.

Subsequently, as shown in FIG. 9C, the sample container 2 and the reagent container 3 are brought close to each other as much as possible, so that the flat surface section 14 provided at the proximal end of the protrusion 4 is brought into close contact with the surface of the film member 9, whereby the mixture of the biological sample A and the reagent B can be prevented from backflow into the reagent container 3.

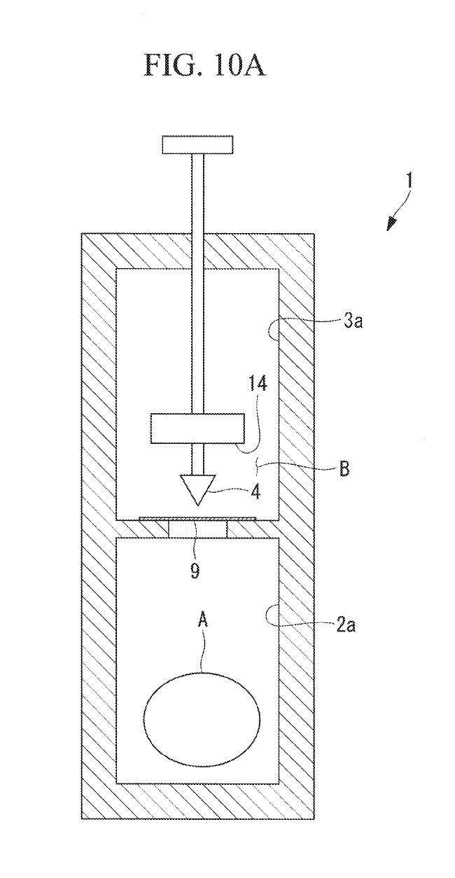

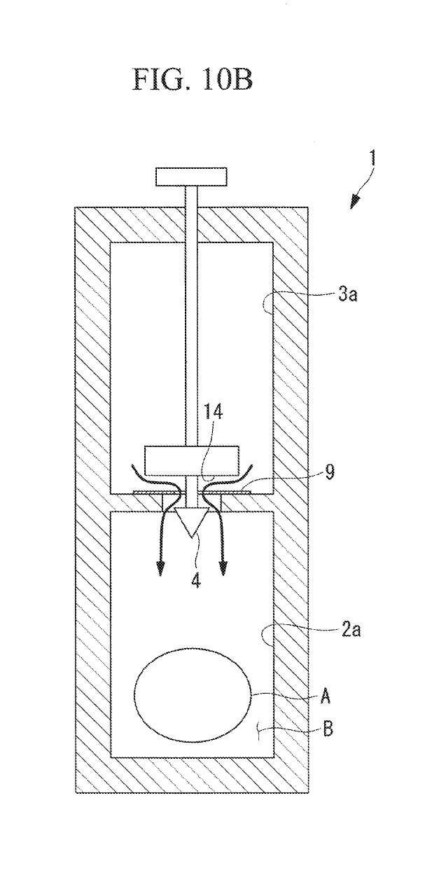

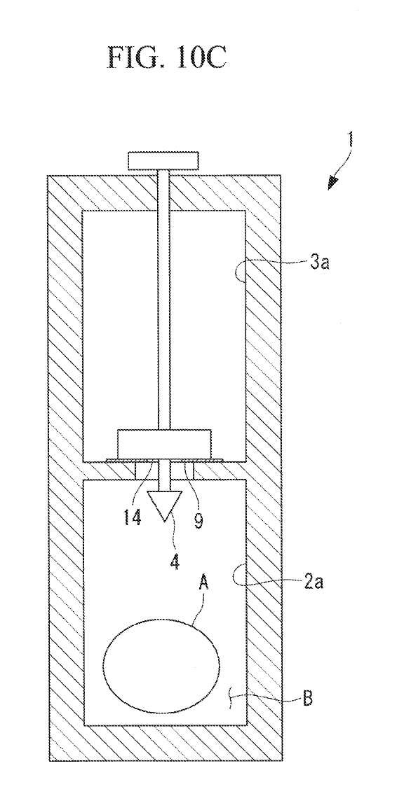

Furthermore, instead of connecting the sample container 2 and the reagent container 3 in a relatively movable manner, the protrusion 4 and the flat surface section 14 may be configured to be movable relative to the film member 9 that separates the reagent containing section 3a and the sample containing section 2a, which are fixed to each other, from each other in a liquid-tight state, as shown in FIGS. 10A to 10C. As shown in FIG. 10B, after forming the through-hole 10 in the film member 9 by using the protrusion 4 and supplying the reagent B to the biological sample A, the flat surface section 14 may be brought into close contact with the surface of the film member 9 so as to close the through-hole 10.

In this case, a syringe having the reagent containing section 3a as a cylinder and the flat surface section 14 as a piston may be configured, and the reagent B may be pushed out from the through-hole 10 by the movement of the flat surface section 14.

The number and shape of the protrusions 4 are not limited, and the through-hole 10 may be formed in the film member 9 by means of an arbitrary number of protrusions 4.

From the above-described embodiments, the following aspects of the present invention are derived.

An aspect of the present disclosure is a biopsy sample container including: a sample containing section capable of containing a biological sample; a reagent containing section capable of containing a reagent; a sealing layer that separates the reagent containing section and the sample containing section from each other in a liquid-tight state; a seal-breaking section that forms a through-hole in the sealing layer by movement relative to the sealing layer; and a resealing section that closes the through-hole formed by the seal-breaking section.

According to this aspect, the reagent is contained in the reagent containing section, the biological sample is contained in the sample containing section separated from the reagent within the reagent containing section by the sealing layer, and the seal-breaking section is moved relative to the sealing layer, so that the through-hole is formed in the sealing layer by the seal-breaking section. The reagent contained in the reagent containing section flows into the sample containing section via the through-hole so as to be mixed with the biological sample.

After the reagent and the biological sample are mixed together, the resealing section closes the through-hole so that the mixture of the reagent and the biological sample is prevented from backflow into the reagent containing section via the through-hole, thereby reducing a loss of the valuable biological sample.

In the above aspect, the reagent containing section may be provided in a first container having an opening sealed by the sealing layer, the sample containing section may be provided in a second container having the seal-breaking section and the resealing section, and the second container and the first container may be connectable in a relatively movable manner.

Accordingly, the first container including the reagent containing section containing the reagent and the second container including the sample containing section containing the biological sample are connected and are moved relative to each other, so as to bring the seal-breaking section close to the sealing layer, which seals the opening of the reagent containing section, and thus form the through-hole in the sealing layer, whereby the reagent and the biological sample can be mixed together. Moreover, by moving the first container and the second container relative to each other, the resealing section provided in the second container is brought close to the through-hole so as to close the through-hole, whereby the mixture of the reagent and the biological sample can be prevented from backflow into the reagent containing section.

Furthermore, in the above aspect, the sealing layer may be a film member disposed so as to close the opening of the first container, the seal-breaking section may be a protrusion capable of piercing the film member, and the resealing section may be a contact member that is brought into close contact with a surface of the film member throughout the entire periphery surrounding the through-hole.

Accordingly, by moving the first container and the second container relative to each other, the through-hole is formed in the film member, which closes the reagent containing section, by means of the protrusion provided in the second container, thus causing the reagent to flow into the sample containing section in which the biological sample is contained. Moreover, by further moving the first container and the second container relative to each other, the contact member provided in the second container is brought into close contact with the surface of the film member surrounding the through-hole, thereby closing the through-hole and preventing the mixture from backflow into the reagent containing section.

Furthermore, the seal-breaking section may include a pointed end that forms the through-hole in the sealing layer and a recess that is disposed closer to a proximal end relative to the pointed end and that is depressed in a direction intersecting a direction in which the seal-breaking section moves relative to the sealing layer.

Accordingly, the sealing layer and the seal-breaking section are moved relative to each other so as to form the through-hole in the sealing layer by means of the pointed end of the seal-breaking section. Then, the sealing layer and the seal-breaking section are further moved relative to each other in the same direction so that the recess is aligned with the through-hole, thereby increasing the opening area of the through-hole and allowing the reagent to flow out readily from the reagent containing section.

The aforementioned aspects afford an advantageous effect in that an operator can mix a reagent and a biological sample together without touching them or without aspirating volatile substances and in that a loss of the biological sample can be reduced.

### REFERENCE SIGNS LIST

A biological sample
B reagent
1 biopsy sample container
2 sample container (second container)
2a sample containing section
3 reagent container (first container)
3a reagent containing section
3b opening
4 protrusion (sealing-breaking section)
4a pointed end
4b recess
6 plate-shaped section (contact member, resealing section)
9 film member (sealing layer)
10 through-hole
14 flat surface section (contact member, resealing section)

1. A biopsy sample container comprising:
a sample containing section capable of containing a biological sample;
a reagent containing section capable of containing a reagent;
a sealing layer that separates the reagent containing section and the sample containing section from each other in a liquid-tight state;
a seal-breaking section that is movable relative to the sealing layer and that forms a through-hole in the sealing layer by movement relative to the sealing layer; and
a resealing section that closes the through-hole formed by the seal-breaking section.

2. The biopsy sample container according to claim 1,
wherein the reagent containing section is provided in a first container having an opening sealed by the sealing layer,
wherein the sample containing section is provided in a second container having the seal-breaking section and the resealing section, and
wherein the second container and the first container are connectable in a relatively movable manner.

3. The biopsy sample container according to claim 2,
wherein the sealing layer is a film member disposed so as to close the opening of the first container,
wherein the seal-breaking section is a protrusion capable of piercing the film member, and
wherein the resealing section is a contact member that is brought into close contact with a surface of the film member throughout the entire periphery surrounding the through-hole.

4. The biopsy sample container according to claim 1,
wherein the seal-breaking section includes a pointed end that forms the through-hole in the sealing layer and a recess that is disposed closer to a proximal end relative to the pointed end and that is depressed in a direction intersecting a direction in which the seal-breaking section moves relative to the sealing layer.
